(19) United States
(12) Patent Application Publication
(10) Pub. No.: US 2012/0069352 A1
(43) Pub. Date: Mar. 22, 2012

(54) METHOD FOR OPTICALLY SCANNING AND MEASURING A SCENE

(75) Inventors: Martin Ossig, Tamm (DE); Reinhard Becker, Ludwigsburg (DE); Alexander Kramer, Kornwestheim (DE)

(73) Assignee: FARO TECHNOLOGIES, INC., Lake Mary, FL (US)

(21) Appl. No.: 13/259,336

(22) PCT Filed: Mar. 22, 2010
(86) PCT No.: PCT/EP2010/001781

§ 371 Date: Dec. 2, 2011

Related U.S. Application Data
(60) Provisional application No. 61/299,103, filed on Jan. 28, 2010.

(30) Foreign Application Priority Data
Mar. 25, 2009 (DE) 10 2009 015 922.3

(51) Int. Cl. G01B 11/24

(52) U.S. Cl. 356/607

(57) ABSTRACT

A method for optically scanning and measuring a scene by means of a laser scanner which, for making a scan having a certain center, optically scans and measures its environment provided with targets, whereby two adjacent scans having different centers and scanning the same scene overlap within a range of measuring points so that some targets are scanned by any of the two scans, whereby, for registering the two adjacent scans, the targets are localized in the measuring points during a first step and, during a second step, candidates of correspondence among the localized targets of the two adjacent scans are looked for and, during a third step, a test registration of the two adjacent scans is made which, if there is a sufficient compliance of the measuring points within the overlapping range, is taken over for registration, thus identifying the targets.

### CROSS REFERENCE TO RELATED APPLICATIONS

The present application is a National Stage Application of PCT Application No. PCT/EP2010/001781 filed on Mar. 22, 2010, which claims the benefit of U.S. Provisional Patent Application No. 61/299,103 filed on Jan. 28, 2010, and of pending German Patent Application No. DE 10 2009 015 922.3, filed on Mar. 25, 2009, and which are hereby incorporated by reference.

### BACKGROUND OF THE INVENTION

The invention relates to a method for optically scanning and measuring a scene.

By means of a laser scanner such as is known for example from U.S. Pat. No. 7,430,068, the surroundings of the laser scanner can be optically scanned and measured. To scan a larger scene, it may be necessary to make several scans from various positions, i.e. with different centers. Targets, which have been previously installed, and which are present in overlapping areas of two adjacent scans, are localized by a user and identified in the two adjacent scans.

### SUMMARY OF THE INVENTION

Embodiments of the present invention are based on the object of improving a method of the type mentioned hereinabove.

The method according to embodiments of the present invention makes it possible to automatically localize and identify the targets, in order to register the adjacent, overlapping scans of the scene together. To reduce the number of combination possibilities, similar geometries may be looked for, in which the targets are embedded, and which may be defined by few further targets, for example by the three closest targets, so that quadrangles result. A pair of potential candidates of correspondence has been found, if two targets from different, adjacent scans are embedded in similar geometries. With the test registration, the two scans are superimposed on a trial basis.

Embodiments of the method of the present invention comprise a global method which even succeeds if the scans are far away from each other, because it is based on the geometry between the targets, i.e. the geometrical relationship between the targets. Therefore, embodiments of the method of the present invention may be used for rough registration as well as for fine registration. Known methods, like “iterative closest points” or other gradient-based dynamics, are local methods which only succeed if the scans are close enough together. Those known methods can only be used for a fine registration (when no secondary minima exist).

In addition to the scans, it is also possible to use data from further measuring units, which are then linked with the scans. This may be an integrated measuring unit such as an inclination sensor or a compass, or an external measuring unit which, for example, carries out a conventional measurement. The registration results can thus be improved and/or the number or required targets can be reduced. It is, for example, also possible to determine the position of one or several targets by means of such measuring units. This facilitates localization of the targets in the scans or defines this localization.

During every step, there will be the problem that, due to the noise level or similar, there is no exact compliance of the measuring points. It is, however, possible to determine threshold values and/or intervals, which serve for discrimination and definition of precision. Formation of gradients, the search for extrema and statistical methods may be applied as well.

### BRIEF DESCRIPTION OF THE DRAWINGS

The invention is explained in more detail below on the basis of exemplary embodiments illustrated in the drawings, in which:

FIG. 1 shows a schematic illustration of the registration of a scene by means of several scans;

FIG. 2 shows a schematic illustration of a laser scanner; and

FIG. 3 shows a sectional detail view of the laser scanner of FIG. 2.

### DETAILED DESCRIPTION OF THE INVENTION

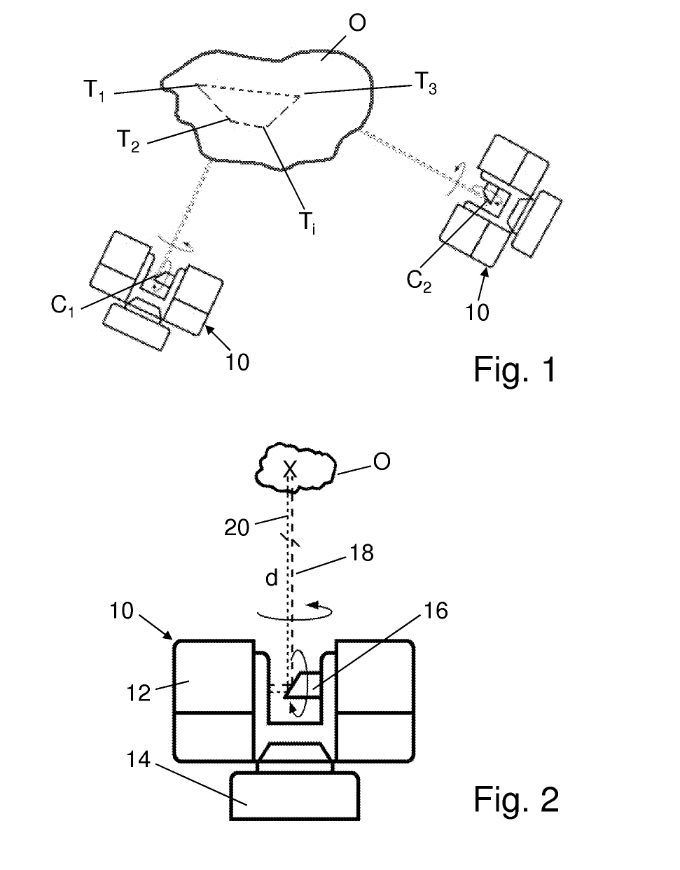

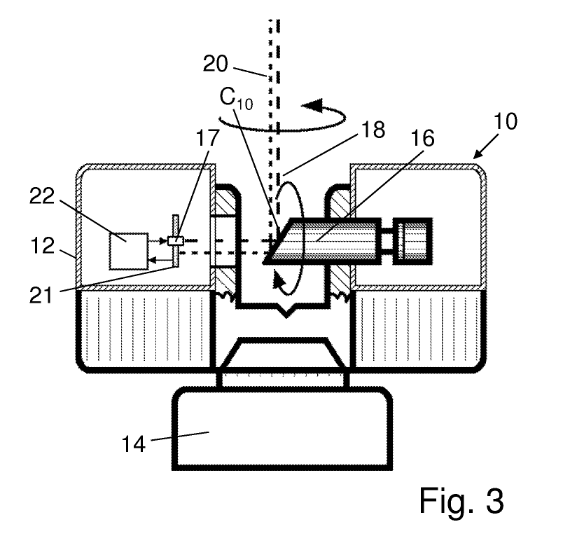

Referring to FIGS. 1-3, a laser scanner 10 is provided as a device for optically scanning and measuring the environment of the laser scanner 10. The laser scanner 10 has a measuring head 12 and a base 14. The measuring head 12 is mounted on the base 14 as a unit that can be rotated around a vertical axis. The measuring head 12 has a mirror 16, which can be rotated around a horizontal axis. The intersection of the two rotational axes is herein designated center Cᵢ of the laser scanner 10.

The measuring head 12 is further provided with a light emitter 17 for emitting an emission light beam 18. The emission light beam 18 may be a laser beam in the visible range of approx. 300 to 1000 nm wavelength, such as 790 nm. Other electromagnetic waves having, for example, a greater wavelength can be used. The emission light beam 18 is amplitude-modulated, for example with a sinusoidal or with a rectangular-waveform modulation signal. The emission light beam 18 is emitted by the light emitter 17 onto the mirror 16, where it is deflected and emitted to the environment. A reception light beam 20, which is reflected in the environment by an object O or scattered otherwise, is captured by the mirror 16, deflected and directed onto a light receiver 21. The direction of the emission light beam 18 and of the reception light beam 20 results from the angular positions of the mirror 16 and the measuring head 12, which depend on the positions of their corresponding rotary drives which, in turn, are registered by one encoder each. A control and evaluation unit 22 has a data connection to the light emitter 17 and the light receiver 21 in measuring head 12, whereby parts of those can be arranged also outside the measuring head 12, for example a computer connected to the base 14. The control and evaluation unit 22 determines, for a multitude of measuring points X, the distance d between the laser scanner 10 and the (illuminated point at) object O, from the propagation time of emission light beam 18 and reception light beam 20. For this purpose, the phase shift between the two light beams 18 and 20 is determined and evaluated.

Scanning takes place along a circle by means of the relatively quick rotation of the mirror 16. By virtue of the relatively slow rotation of the measuring head 12 in relation to the base 14, the whole space is scanned step by step, by means of the circles. The entity of measuring points X of such a measurement is designated scan. The center Cᵢ of the laser scanner 10 defines the stationary reference system of the laser scanner 10 for such a scan, in which the base 14 rests. Further details of the laser scanner 10 and particularly of the design of measuring head 12 are described for example in U.S. Pat. No. 7,430,068 and DE 20 2006 005 643, the respective disclosures being incorporated by reference.

A scan of a certain scene is made by optically scanning and measuring the environment of the laser scanner 10. Scenes, which cannot be registered with one single scan, such as a framework structure or objects O with many undercuts, are possible. For this purpose, the laser scanner 10 is set up at different positions, and the scanning and measuring process is repeated, i.e. one scan is made with a defined center Cᵢ, which always registers the same scene, but from a different viewing angle. The different scans of the same scene are registered in a joined coordinate system, which is designated registering (visual registering).

Before a scan is made, several targets T₁, T₂, . . . , (i.e. special objects O) are suspended in the environment. The laser scanner 10 is then set up in a new position for several times, i.e. a new center Cᵢ is defined, and a scan is made for each position. The whole scene is then registered by several scans having different centers C₁, C₂. Adjacent scans overlap so that several (for example, three) targets T₁, T₂ . . . are registered by two adjacent scans each. Spheres and checker-board patterns have turned out to be particularly suitable targets.

Until now, the targets T₁, T₂, . . . have been localized and identified manually in the scans, in order to register the measurements. According to embodiments of the present invention, registration takes place automatically.

For this purpose, the targets T₁, T₂, . . . are localized in the scans, as a first step. In the case of a sphere, this information can be gained from the distances d, which join together to a uniformly bent, round shape, i.e. to a hemisphere. In the case of the checker-board pattern, gradients can be recognized in two directions. Several measuring points X, for example at least 50-100, for each target Tᵢ, help to avoid errors in localizing the targets T₁, T₂, . . . . Filters with threshold values can help to avoid further localization errors. In addition, data from further measuring units, which are incorporated in the laser scanner 10, or from external measuring units can be used, which facilitate or define localization in the scans for one or several targets T₁, T₂, . . . .

In a second step, potential candidates of correspondence are looked for. For each scan, the distances (or alternatively the angles) for several localized targets Tᵢ, between the corresponding target Tᵢ and the other (or at least the closest) targets T₁, T₂, . . . are determined from the distances d, resulting in certain geometries, in which the corresponding targets Tᵢ are embedded, for example three-dimensional quadrangles together with the three closest targets T₁, T₂, . . . . Similar geometries are looked for when comparing with the adjacent scans. As soon as two targets Tᵢ, which come from two different adjacent scans, are embedded in a similar geometry, i.e. the distances at least to the closest targets T₁, T₂, . . . correspond to each other within a certain precision interval, a pair of candidates of correspondence has been found.

In a third step, a test registration is carried out, i.e. the adjacent scans are transformed in relation to each other by translation and rotation, until the candidates of correspondence and the geometries, in which they are embedded, show a minimum distance. Then, all measuring points X, which are present in both scans, i.e. which are within the overlapping range of the two scans, are compared by means of statistical methods. It is possible, for example, to determine the distances, and the sum of the distances may be a measure of the (missing) compliance. If the statistically gained compliance exceeds a certain threshold value, the targets T₁, T₂, . . . have been identified, and the test registration is taken over for registration. If the compliance is not sufficient, the pair of candidates of correspondence is rejected, and identification of the targets T₁, T₂, . . . by means of the second and the third step is repeated.

Since the search for candidates of correspondence, particularly in the case of many targets T₁, T₂, . . . , may create problems due to non-linearity, it is possible to use only few targets T₁, T₂, . . . , i.e. small embedded geometries for the search for candidates of correspondence, and to undertake the test registration with all targets T₁, T₂, . . . . This increases the performance of the whole method.

1. A method for optically scanning and measuring a scene by means of a laser scanner, which, for making a scan which shows a certain center, optically scans and measures its environment which is provided with targets, whereby two adjacent scans having different centers and scanning the same scene overlap within a range of measuring points, so that at least some targets are scanned by any of the two scans, the method comprising the steps of:
registering the two adjacent scans by localizing the targets in the measuring points of the two adjacent scans, in order to subsequently identify them;
looking for candidates of correspondence among the localized targets of the two adjacent scans; and
performing a test registration of the two adjacent scans, wherein if there is a sufficient compliance of the measuring points within the overlapping range, the test registration is taken over for registration, thereby identifying the targets.

2. The method of claim 1, wherein the step of registering the two adjacent scans localize the targets by virtue of a shape and/or gradients of the targets.

3. The method of claim 1, wherein the step of looking for candidates for correspondence further comprises the step of determining, for at least one of the localized targets in any of the two scans, a geometry in which one of the localized targets is embedded and which results from the closest targets.

4. The method of claim 1, wherein the step of looking for candidates for correspondence further comprises looking for similar geometries from among the geometries of the two adjacent scans embedding the localized targets.

5. The method of claim 4, wherein a pair of candidates of correspondence is found as soon as two targets, which stem from different of the two adjacent scans, are embedded in a similar geometry.

6. The method of claim 3, wherein the embedded geometry results from determined distances and/or angles between the localized target and the closest targets.

7. The method of claim 6, wherein the embedded geometries are similar if the distances between the localized target and the closest targets correspond to each other within a certain precision interval.

8. The method of claim 1, wherein the step of performing a test registration of the two adjacent scans further comprises transforming the two adjacent scans in relation to each other so that the candidates of correspondence show a minimum distance.

9. the method of claim 8, wherein the measuring points within the overlapping range are compared by statistical methods, if the candidates of correspondence show a minimum distance.

10. The method of claim 1, wherein the laser scanner is set up at different positions for optically scanning and measuring the scene, in order to make one scan each, whereby the laser scanner defines the corresponding center of the scan in each position.
